(19) United States
(12) Patent Application Publication
(10) Pub. No.: US 2025/0370678 A1
(43) Pub. Date: Dec. 4, 2025

(54) IMAGE FORMING APPARATUS, CONTROL METHOD, AND COMPUTER-READABLE STORAGE MEDIUM STORING PROGRAM

(71) Applicant: CANON KABUSHIKI KAISHA, Tokyo (JP)

(72) Inventors: Moritaka Iwakoshi, Kanagawa (JP); Ryuhei Wakita, Tokyo (JP); Takanobu Suzuki, Kanagawa (JP); Kazunari Shishido, Kanagawa (JP)

(21) Appl. No.: 19/226,249

(22) Filed: Jun. 3, 2025

(30) Foreign Application Priority Data
Jun. 4, 2024 (JP) 2024-090922

(51) Int. Cl. G06F 3/12

(52) U.S. Cl. CPC G06F 3/1258; G06F 3/1204

(57) ABSTRACT

A method for controlling an image forming apparatus, the method including: acquiring print setting information and print data that includes page data for at least one page; if single-sided printing is set to the print data in the print setting information and the print data is set to be printed by multilayer printing, generating image data by executing, on the page data as layer data, image processing based on setting established by establishing; and controlling printing in which printing is executed by the multilayer printing on a printing medium based on the image data generated by the generating.

### BACKGROUND

### Field of the Technology

The present disclosure relates to an image forming apparatus, a control method, and a computer-readable storage medium storing a program that are capable of executing multilayer printing.

### Description of the Related Art

There is known a technique of making a first print image and a third print image respectively visible from opposite sides of a printing medium such as a transparent window glass or film by, on the printing medium, forming the first print image, forming a second print image that masks the first print image, and forming the third print image from over the second print image. Japanese Patent Laid-Open No. 2014-166762 discloses a control method in which a first print image, a second print image that masks the first print image, and a third print image are printed one over another. Furthermore, there is known a technique of making a print image only visible from the back side of a printing medium by forming a first print image and a second print image that masks the first print image one over the other on the printing medium. Also, there is known a technique of making a print image only visible from the front side of a printing medium by forming a second print image that masks a print image, and forming a third print image over the second print image on the printing medium.

### SUMMARY

The present disclosure provides an image forming apparatus, a control method, and a computer-readable storage medium storing a program that are for performing control such that a print job including page data set for single-sided printing is printed by multilayer printing based on a setting of whether or not to provide a masking layer for each page data.

The present disclosure in one aspect provides an image forming apparatus comprising: at least one memory and at least one processor which function as: an acquiring unit configured to acquire print setting information and print data that includes page data for at least one page; a first setting unit configured to set whether or not to print the print data by multilayer printing; a second setting unit configured to establish, for each of the page data, a setting of whether or not to execute a printing mode for forming a masking layer in a printed material to be obtained by the multilayer printing; a generating unit configured to, if single-sided printing is set to the print data in the print setting information and the print data is set to be printed by the multilayer printing, generate image data by executing, on the page data as layer data, image processing based on the setting established by the second setting unit; and a control unit configured to control a printing unit so as to execute printing by the multilayer printing on a printing medium based on the image data generated by the generating unit.

According to the present disclosure, control can be performed such that a printed material similar to that in a case in which double-sided printing is executed is output by multilayer printing based on a setting of whether or not provide a masking layer for each page data set for single-sided printing.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a configuration of an image forming apparatus.

FIG. 2 is a diagram illustrating an external appearance of the image forming apparatus.

FIG. 3 is a diagram illustrating the external appearance of the image forming apparatus.

FIG. 4 is a schematic cross-sectional view of a vicinity of a printing mechanism of the image forming apparatus.

FIG. 5 is a diagram illustrating a functional block configuration of a printer controller.

FIGS. 6A and 6B are flowcharts illustrating processing by the printer controller.

FIGS. 7A and 7B are flowcharts illustrating processing by the printer controller.

FIG. 8 is a diagram illustrating an example of a multilayer-printing setting screen.

FIG. 9 is a diagram illustrating a multilayer-printing individual-layer setting screen.

FIG. 10 is a diagram illustrating a multilayer-printing individual-layer setting screen.

FIG. 11 is a diagram illustrating a multilayer-printing individual-layer setting screen.

FIG. 12 is a diagram illustrating a multilayer-printing individual-layer setting screen.

FIGS. 13A to 13D are diagrams each illustrating a multilayer-printing individual-layer setting screen.

FIGS. 14A to 14D are diagrams each illustrating a multilayer-printing individual-layer setting screen.

FIGS. 15A to 15E are diagrams for describing printed materials in a case in which multilayer printing is executed.

FIG. 16 is a diagram illustrating a screen for setting ink thickness for different types of printing media.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Among conventional techniques, there is no mention of control such that a printed material similar to that in a case in which double-sided printing is executed is output by multilayer printing based on a setting of whether or not to provide a masking layer for each page data set for single-sided printing.

According to the present disclosure, control can be performed such that a print job including page data set for single-sided printing is printed by multilayer printing based on a setting of whether or not to provide a masking layer for each page data.

### First Embodiment

### Basic Apparatus Configuration

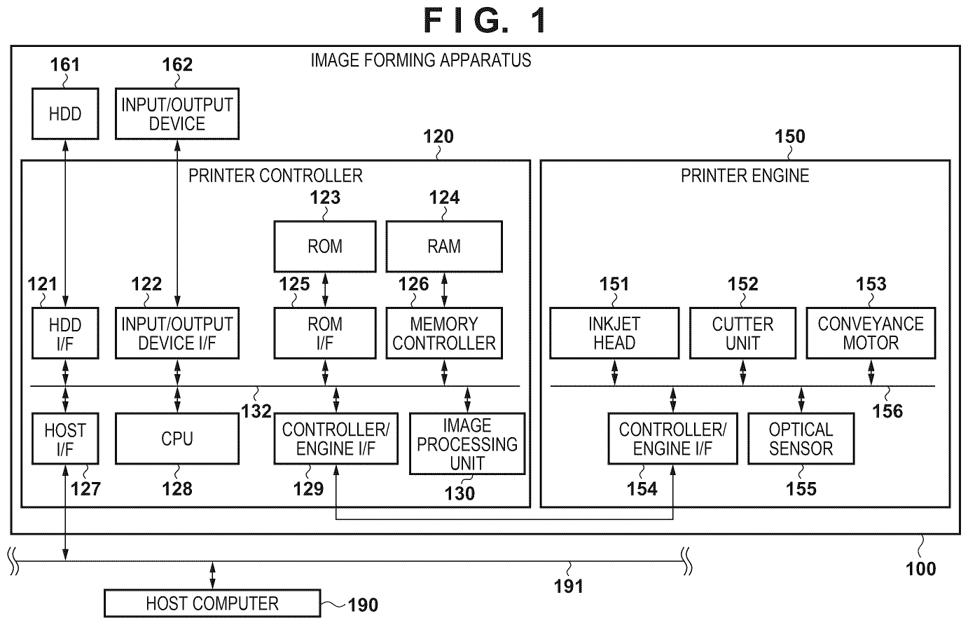

FIG. 1 is a block diagram illustrating a configuration of an image forming apparatus in the present embodiment. Note that, while a printing apparatus only having a printing function will be described as the image forming apparatus in the present embodiment, there is no limitation to this. For example, the image forming apparatus may be an image forming apparatus that further includes a reading device for reading images on documents and functions as a copier, or an image forming apparatus that is configured as a multi-function peripheral (MFP) having other functions added thereto.

In FIG. 1, an image forming apparatus 100 is configured to include a printer controller 120, a printer engine 150, an HDD 161, and an input/output device 162. Furthermore, the image forming apparatus 100 can be connected to a host computer 190 via a network 191. The printer controller 120 includes an HDD interface (I/F) 121, an input/output device I/F 122, a ROM I/F 125, and a memory controller 126. Furthermore, the printer controller 120 includes a host I/F 127, a central processing unit (CPU) 128, a controller-engine interface 129, and an image processing unit 130. Such components are mutually connected via a system bus 132. Furthermore, the printer controller 120 includes a ROM 123 and a RAM 124. The ROM 123 is a flash ROM, for example, and is connected to the system bus 132 via the ROM I/F 125. The RAM 124 is connected to the system bus 132 via the memory controller 126.

The CPU 128 is a central processing unit in the form of a microprocessor (microcomputer), and controls the operation of the entire image forming apparatus 100 by executing programs and activating hardware. The ROM 123 stores therein programs to be executed by the CPU 128 and various types of data necessary for the operation of the image forming apparatus 100. The RAM 124 is used as a work area of the CPU 128, is used as a temporary storage area for various types of received data, and stores various types of setting data.

The image processing unit 130 executes various types of image processing. For example, the image processing unit 130 executes processing for expanding (converting) print data (e.g., data expressed in a page description language) handled by the image forming apparatus 100 into image data (e.g., bitmap image data). In the present embodiment, data obtained by the image processing unit 130 executing image processing on print data received from the host computer 190 or an external server is referred to as image data. Furthermore, the image processing unit 130 converts a color space (e.g., YCbCr color space) defined by input print data into a standard RGB color space (e.g., sRGB color space). Furthermore, various processing such as the conversion of resolution into the number of pixels that the image forming apparatus 100 can process, image analysis, and image correction may be executed as image processing by the image processing unit 130. Image data obtained as a result of image processing by the image processing unit 130 is stored in the RAM 124 or the HDD 161.

The printer engine 150 is a printing unit that forms images. The printer engine 150 includes an inkjet print head 151 (hereinafter “print head 151”), a cutter unit 152, a conveyance motor 153, a controller-engine interface 154 that is an interface with the printer controller 120, and an optical sensor 155. The components are mutually connected via a system bus 156.

The print head 151 is a printing unit that forms an image on a printing medium (also referred to as recording medium) based on image data. For example, the print head 151 holds nozzle arrays corresponding to a plurality of colors, and an image is formed on a printing medium by causing ink to be ejected from the print head 151 in synchronization with the conveyance of the printing medium. Note that, while an inkjet-recording-type printing apparatus in which ink is used as a recording material will be described as an example of the image forming apparatus 100, there is no limitation to this. Printing apparatuses of various recording methods, such as a thermal printer (sublimation type, heat transfer type, etc.), a dot impact printer, and an electrophotographic-type printing apparatus, such as an LED printer or a laser printer, may be used as the image forming apparatus 100. Furthermore, in the present embodiment, colors of recording materials that can be used in the image forming apparatus 100 include white and black as specific colors used to mask an image printed on the other side of a printing medium when the printing medium is viewed from one side. Furthermore, in the present embodiment, a transparent printing medium such as a transparent film or glass is used as the printing medium. Furthermore, while it is assumed in the present embodiment that the printing medium is a roll-shaped printing medium, the printing medium may be a cut printing medium.

The cutter unit 152 is a mechanism for cutting the roll-shaped printing medium (roll sheet). The cutter unit 152 cuts the roll sheet after printing into a predetermined length. Note that, in a case in which a type of printing medium that releases paper dust when cut by the cutter unit 152 is used, a setting for printing a cutting dust reduction line at a cutting position may be stored in the ROM 123 in advance in order to prevent the scattering of paper dust during cutting. Furthermore, separately from the setting of the cutting dust reduction line, operation settings of the cutter unit 152 for different types of printing media may be stored in the ROM 123 in advance. For a type that cannot be cut using the cutter unit 152, a setting (user cut) for not moving the cutter unit 152 may be stored in advance in the ROM 123 because the user will perform cutting using scissors. Furthermore, for a type in which the cutting line would be curved if cutting is not performed while the user is holding the roll sheet, a setting (eject cut) such that the cutter unit 152 operates in accordance with a user operation may be stored in advance in the ROM 123. For types for which user cut and eject cut are not set, a setting (auto cut) for performing automatic cutting using the cutter unit 152 may be stored in advance in the ROM 123.

The conveyance motor 153 is a motor for driving a conveyance roller for conveying the roll sheet, and is controlled by the CPU 128. The optical sensor 155 is a measurement mechanism for measuring attribute values of the printing medium, and is a reflective optical sensor configured to include a light emitting diode (LED) serving as a light-emitting element, a specular-reflection-light light-receiving element, a diffused-light light-receiving element, etc. The image forming apparatus 100 uses the optical sensor 155 and measures, as attribute values, the intensities of specular reflection light and diffused light from the printing medium on a platen, the thickness of the printing medium, etc.

The input/output device 162 includes hardware keys and a panel allowing a user to perform various types of operations, and a display unit for displaying various types of information to the user. Furthermore, the input/output device 162 may notify the user of information by outputting sound (alarm, voice, etc.) based on sound information from a sound generator. As a result of the user selecting a printing medium type by using the input/output device 162 upon feeding a printing medium, the image forming apparatus 100 performs conveyance control of the printing medium based on the setting information for different types.

The HDD 161 is a non-volatile storage area, and stores therein programs to be executed by the CPU 128, print data, and setting information necessary for various types of operations of the image forming apparatus 100. Note that, in place of the HDD 161, a different high-capacity storage device such as a flash memory may be used.

Note that, while a configuration in which the input/output device 162 is present inside the image forming apparatus 100 is adopted in the present embodiment, there is no limitation to this. For example, the input/output device 162 may be connected via the network 191 as an external component. Furthermore, a configuration may be adopted such that the host computer 190 operates as the input/output device 162. Furthermore, the image forming apparatus 100 may be configured so that other input/output devices other than the input/output device 162 can be further connected via the network 191, etc.

For example, the host computer 190 is an external device that functions as a supply source of print data, and has a printer driver installed therein. Print data is data that is created by an application on the host computer 190 and transmitted to the image forming apparatus 100 via the printer driver. In the present embodiment, as an example, a print job including print data, print setting information, and a command is transmitted from the host computer 190 to the image forming apparatus 100. The application is an application via which single-sided printing or double-sided printing can be designated, and the print setting information is information set via the application. However, single-sided printing, double-sided printing, etc., may be set via the printer driver, and the print setting information may be information set via the printer driver.

In place of the host computer 190, a data providing device that serves as the supply source of print data, such as a reader for image reading, a digital camera, or a smartphone, for example, may be provided. The image forming apparatus 100 and the host computer 190 can mutually communicate via the network 191. The network 191 is a wired network, a wireless network, or a network in which both wired and wireless networks are present.

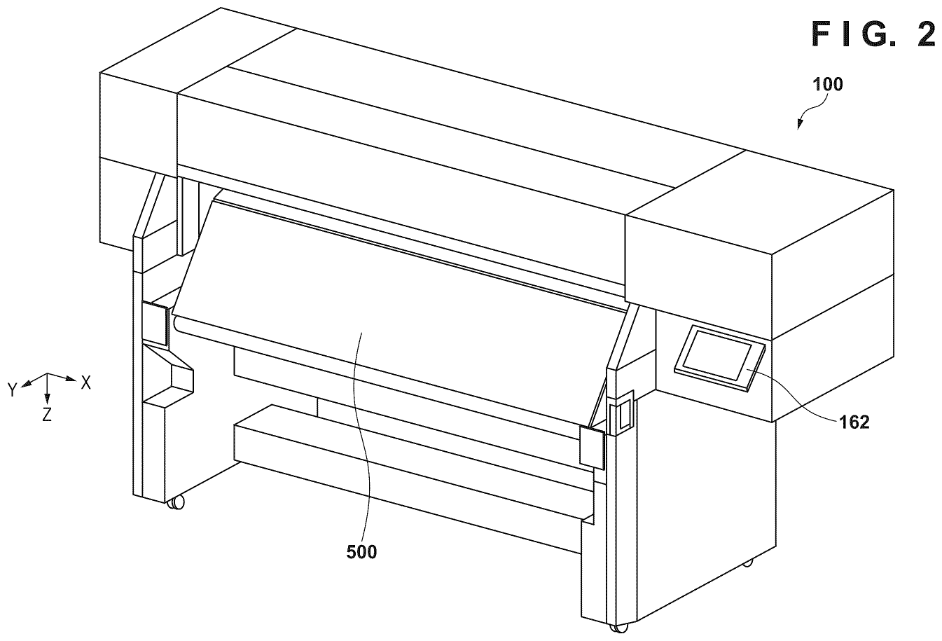

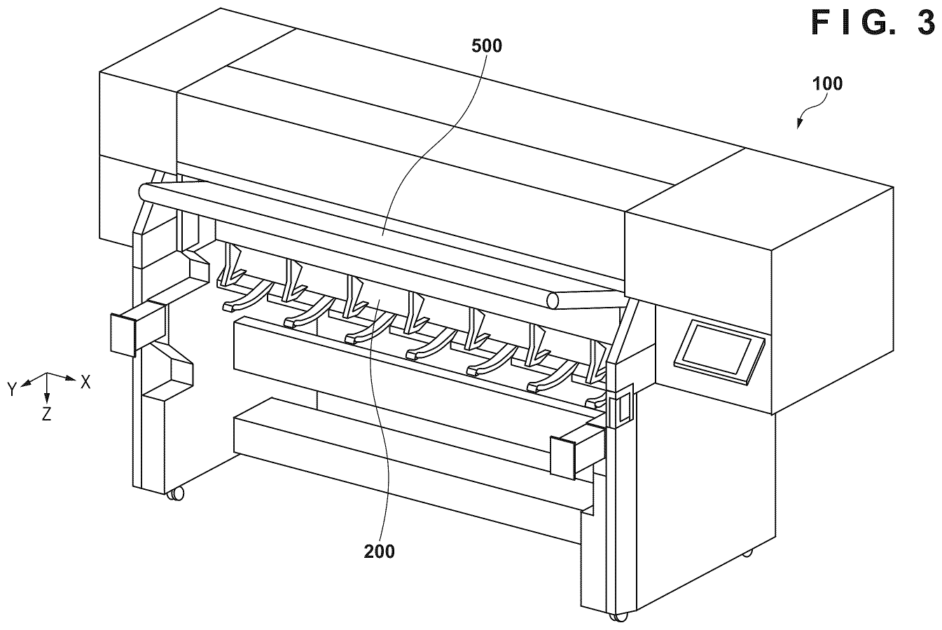

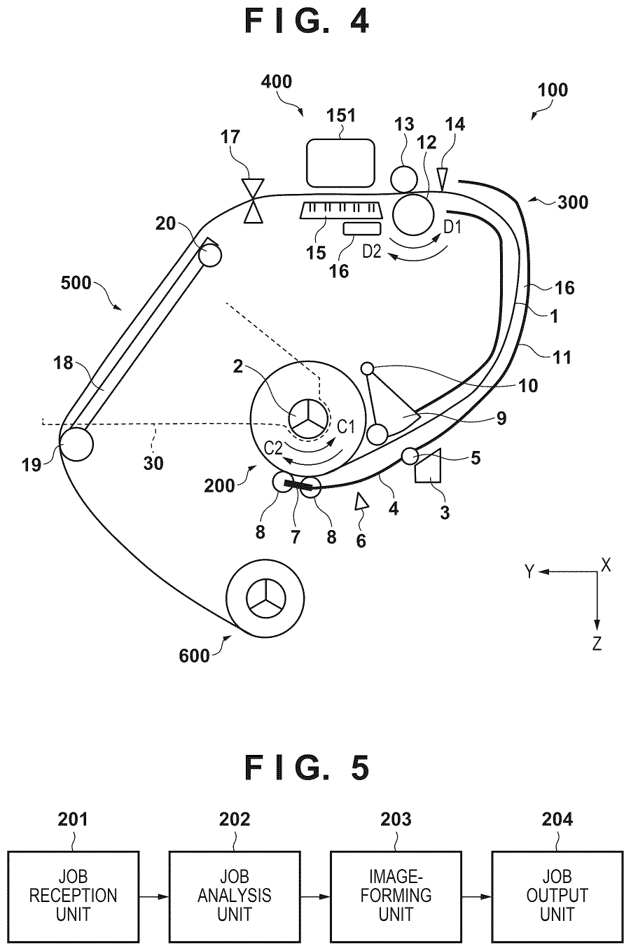

FIG. 2 is a diagram illustrating an external appearance of the image forming apparatus 100. The image forming apparatus 100 is configured to be capable of feeding a roll sheet obtained by winding a sheet in the shape of a roll and rewinding the printed sheet. The input/output device 162 includes hardware keys and a panel allowing the user to perform various types of operations, and a display unit for displaying various types of information to the user. Furthermore, the input/output device 162 may notify the user of information by outputting sound (alarm, voice, etc.) based on sound information from a sound generator. As a result of the user selecting a printing medium type by using the input/output device 162 upon feeding a printing medium, the image forming apparatus 100 performs conveyance control of the printing medium based on the setting information for different types. When a paper-discharge guide portion 500 is in an open state, the user can set a roll sheet in a roll setting portion 200 illustrated in FIG. 3. FIG. 3 is a perspective view of the image forming apparatus 100 during setting of a roll sheet. When the paper-discharge guide portion 500 is in a closed state, a sheet drawn out from the roll sheet set in the roll setting portion 200 arrives at a printing unit 400 via a sheet conveyance portion 300, and is discharged to the paper-discharge guide portion 500 after an image is printed thereon by the printing unit 400, as illustrated in FIG. 4. The user can use the various types of switches, etc., included in the input/output device 162 to input, on the input/output device 162, various types of commands, etc., for the image forming apparatus 100, such as a designation of roll sheet size and a setting of roll sheet type.

FIG. 4 is a schematic cross-sectional view of the vicinity of a printing mechanism of the image forming apparatus 100. A sheet 1 drawn out from the roll sheet set in the roll setting portion 200 is rewound by a rewinding portion 600. The sheet 1 drawn out from the roll sheet set in the roll setting portion 200 is conveyed to the printing unit 400, which is capable of image printing, through the sheet conveyance portion 300. The printing unit 400 forms (prints) an image on the sheet 1 by ejecting ink droplets from ejection ports (nozzles) of the print head 151. The print head 151 ejects ink droplets from each ejection port using an ejection-energy-generating element such as an electrothermal conversion element (heater) or a piezoelectric element. In a case in which an electrothermal conversion element is used, ink is bubbled by heat generated by the electrothermal conversion element, and ink droplets are ejected from the ejection port using the bubbling energy. Furthermore, for example, the print head 151 may be a print head that is driven according to the serial scan method or the full line method. In the case of the serial scan method, an image is formed on the printing medium by an operation of conveying the sheet 1 and movement of the print head 151 in a direction intersecting the conveyance direction of the sheet 1 being performed. In the case of the full line method, a long print head 151 that extends in the direction intersecting the conveyance direction of the sheet 1 is used to form an image on the printing medium while continuously conveying the sheet 1.

A shaft-shaped roll-supporting member 2 is inserted into a hollow hole portion of the roll sheet, and the roll-supporting member 2 is driven in the forward and reverse directions by a roll-driving motor. Thus, the roll sheet is caused to rotate in the forward direction or the reverse direction (direction of arrow C1 or C2) in a state in which the center portion of the roll sheet is held. The roll setting portion 200 includes a driving portion 3, an arm member (moving body) 4, an arm rotation shaft 5, a first sheet sensor 6, a swinging member 7, passive rotating bodies (pressure contact bodies) 8, a separation flapper (upper guide body) 9, and a flapper rotation shaft 10.

A paper-feed-side conveyance guide 11 guides the sheet 1 drawn out from the roll setting portion 200 to the printing unit 400 while guiding the front and back sides of the sheet 1. A conveyance roller 12 is rotated in the forward direction or the reverse direction (direction of arrow D1 or D2) by a conveyance-roller driving motor. A nip roller 13 can passively rotate in accordance with the rotation of the conveyance roller 12; the nip roller 13 can be brought into contact with or separated from the conveyance roller 12 by an unillustrated nip-roller separation motor, and the nip force thereof can also be adjusted by the unillustrated nip-roller separation motor. The conveyance roller 12 starts to rotate when the front end of the sheet 1 is detected by a second sheet sensor 14. The speed of conveyance of the sheet 1 by the conveyance roller 12 is set to be higher than the speed at which the sheet 1 is drawn out by the rotation of the roll sheet, whereby back tension is applied to the sheet 1 to convey the sheet 1 while maintaining the sheet 1 in a tensioned state. Thus, drooping of the sheet 1 can be prevented, and the occurrence of folds in the sheet 1 and the occurrence of conveyance errors can be suppressed.

A platen 15 in the printing unit 400 attracts the back side of the sheet 1 via suction holes provided in the platen 15 by negative pressure generated by a suction fan 16. Thus, high-precision image printing by the print head 151 can be realized as a result of the position of the sheet 1 being regulated along the top of the platen 15. A cutter 17 cuts the sheet 1 on which an image has been printed.

A paper-discharge-side conveyance guide 18 provided in the paper-discharge guide portion 500 guides the sheet 1 to the rewinding portion 600 while guiding the back side of the sheet 1 drawn out from the printing unit 400. Here, the sheet 1 printed by the printing unit 400 can be continuously rewound by fixing the front end of the sheet 1 to a paper tube set in the rewinding portion 600 and rotating the set paper tube in accordance with the conveyance speed of the conveyance roller 12. By providing a passive roller 19 at the rewinding-side end portion of the paper-discharge-side conveyance guide 18, the occurrence of damage to the sheet 1 due to being bent at position of the passive roller 19 can be prevented. Furthermore, the conveyance resistance at the bent portion is reduced, and the occurrence of a large deflection between the conveyance roller 12 and the passive roller 19 is prevented. By adopting a configuration in which the sheet 1 moves along the paper-discharge-side conveyance guide 18, it is possible to heat the paper-discharge-side conveyance guide 18 by an unillustrated heating unit and assist the heat-fixing of ink ejected by the printing unit 400 to the sheet 1. The paper-discharge-side conveyance guide 18 and the passive roller 19 can be rotated about a discharge guide rotation shaft 20. Thus, when a roll sheet is to be attached to or removed from the roll setting portion 200, the roll sheet can be set without interference with the paper-discharge guide portion 500 by retracting the paper-discharge-side conveyance guide 18 and the passive roller 19 upward by rotation as illustrated in FIG. 3.

In the following, processing in a case in which the image forming apparatus 100 receives a print job designated for single-sided printing will be described. In the present embodiment, a printed material similar to that when double-sided printing is executed can be output by multilayer printing, by controlling print data on the image-forming-apparatus-100 side without considering multilayer printing on the application side.

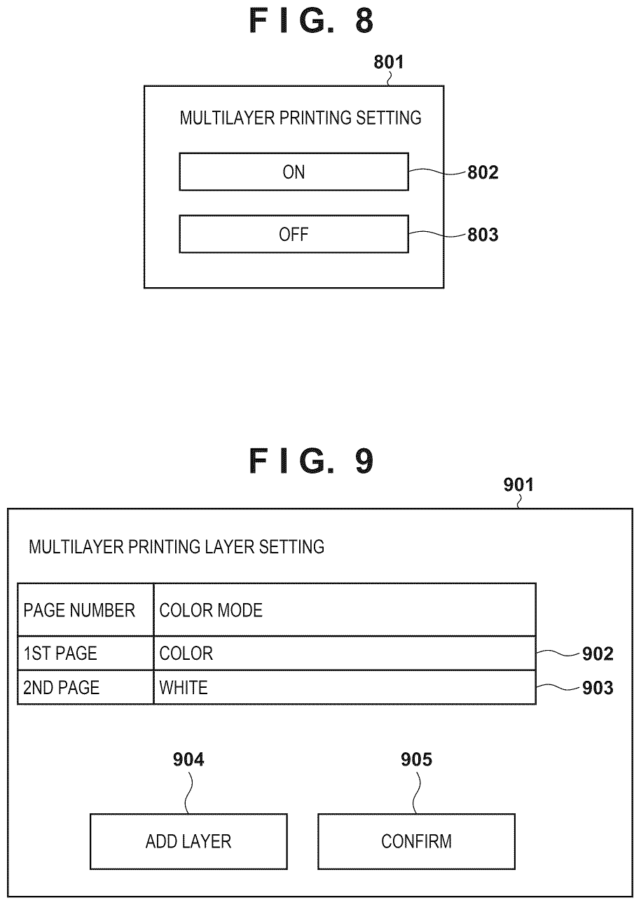

FIG. 5 is a diagram illustrating a functional block configuration of the printer controller 120. The printer controller 120 includes a job-receiving unit 201, a job-analyzing unit 202, an image-forming unit 203, and a job-outputting unit 204. The job-receiving unit 201 acquires a print job by receiving the print job from the host computer 190 or receiving the print job from an unillustrated server via the network 191. The job-analyzing unit 202 analyses print setting information included in the print job acquired by the job-receiving unit 201. Note that processing by the job-analyzing unit 202 is not limited to analyzing the print setting information, and the job-analyzing unit 202 may also execute other processing such as referring to apparatus settings. The image-forming unit 203 generates image data by executing image processing using the image processing unit 130 on print data. The generation of the image data involves expansion into an image buffer. The job-outputting unit 204 outputs the generated image data to the printer engine 150. Based on the image data, the printer engine 150 forms an image on the printing medium. If a setting to execute multilayer printing has been established on the later-described screen in FIG. 8, the printer engine 150 forms the image by multilayer printing.

In the present embodiment, the image-forming unit 203 processes page data for at least one page included in the print data as layer data by allocating the page data to respective layers in multilayer printing. Specifically, if single-sided printing is set in the print setting information, the image-forming unit 203 allocates each page data included in the print data to a corresponding layer based on the later-described apparatus settings. Then, image data is generated by print data allocated to each layer being expanded into the image buffer.

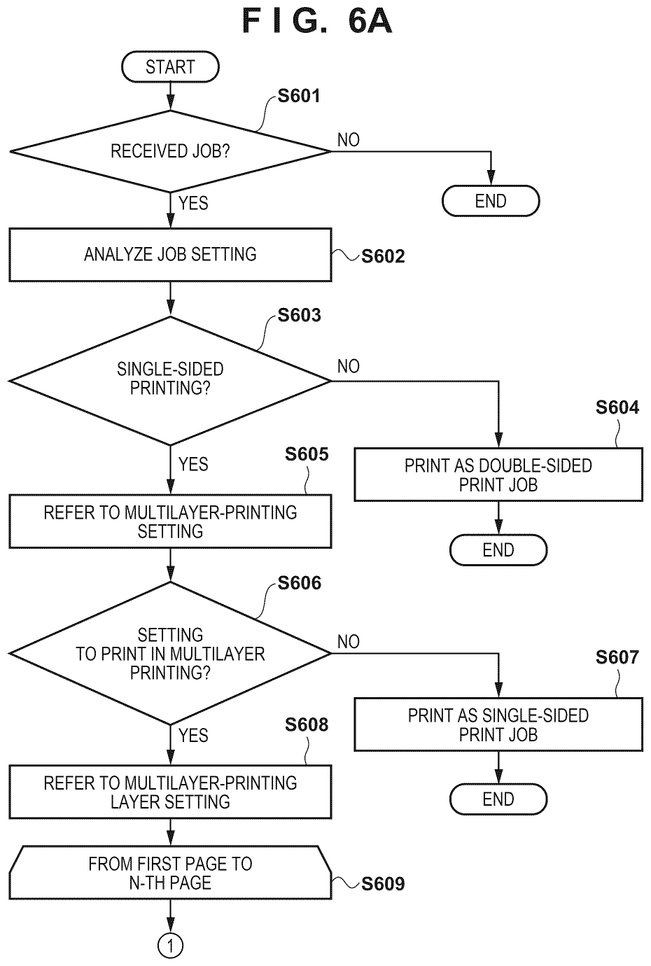

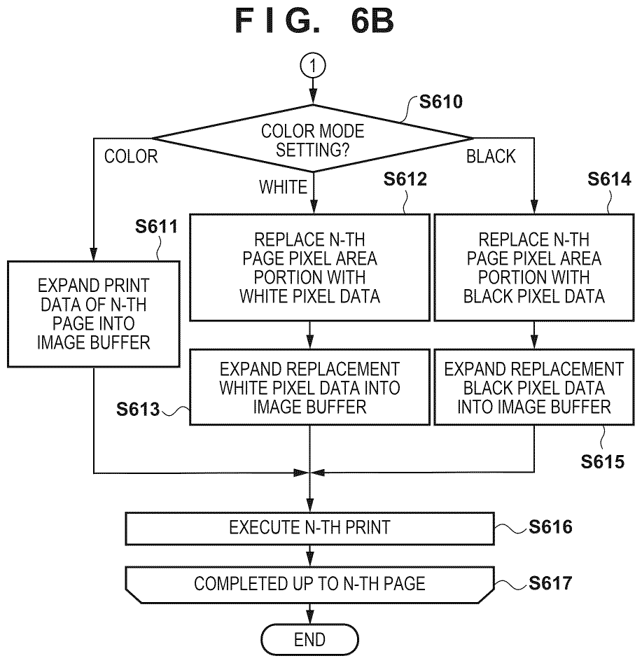

FIGS. 6A and 6B are flowcharts illustrating processing by the printer controller 120 in a case in which a print job is received in the present embodiment. For example, the processing in FIGS. 6A and 6B are realized by the CPU 128 loading a program stored in the ROM 123 into the RAM 124 and executing the program.

In step S601, the printer controller 120, using the job-receiving unit 201, receives a print job transmitted from the host computer 190. In step S602, the printer controller 120, using the job-analyzing unit 202, analyzes print setting information included in the print job. For example, the print setting information includes a setting designating single-sided printing or a setting designating double-sided printing.

In step S603, the printer controller 120, using the job-analyzing unit 202, determines whether or not single-sided printing is designated in the print setting information. Here, the printer controller 120 advances to step S604 if it is determined that single-sided printing is not designated. In step S604, the printer controller 120 executes the print job as a double-sided print job, and then terminates the processing in FIGS. 6A and 6B. On the other hand, the printer controller 120 advances to step S605 if it is determined in step S603 that single-sided printing is designated. In step S605, the printer controller 120, using the job-analyzing unit 202, refers to multilayer-printing setting information set via the input/output device 162. The multilayer-printing setting information is information indicating whether or not printing by the job-outputting unit 204 is to be executed as multilayer printing. For example, this information is set to the image forming apparatus 100 by a user operation performed via a setting screen displayed on the input/output device 162.

FIG. 8 is a diagram illustrating an example of a multilayer-printing setting screen. A multilayer-printing setting screen 801 is a screen displayed on the input/output device 162, and the user selects and sets to the image forming apparatus 100 in advance whether or not to execute multilayer printing. In other words, the multilayer-printing setting screen 801 is a screen for setting whether to enable or disable multilayer printing. The multilayer-printing setting screen 801 includes a button 802 for accepting a selection to execute multilayer printing and a button 803 for accepting a selection not to execute multilayer printing. Furthermore, the printer controller 120 controls print processing of a print job designated for single-sided printing based on the setting established on the multilayer-printing setting screen 801. If the button 803 is selected, a print job designated for single-sided printing is printed page by page as a single-sided print job. That is, multilayer printing is not executed in this case. On the other hand, if the button 802 is selected, a print job designated for single-sided printing is printed as a multilayer print job. That is, multilayer printing is executed in this case.

In step S606, the printer controller 120 determines whether or not to execute printing by multilayer printing based on the setting established on the multilayer-printing setting screen 801. The printer controller 120 advances to step S607 if it is determined not to execute printing by multilayer printing. In step S607, the printer controller 120 executes the print job as a single-sided print job for individual pages, and then terminates the processing in FIGS. 6A and 6B. On the other hand, the printer controller 120 advances to step S608 if it is determined to execute printing by multilayer printing. In step S608, the printer controller 120, using the job-analyzing unit 202, refers to multilayer-printing layer setting information set via the input/output device 162. For example, the multilayer-printing layer setting information is setting information of whether or not to execute, for each page data included in the print job, a printing mode for providing a masking layer in the printed material to be obtained by multilayer printing.

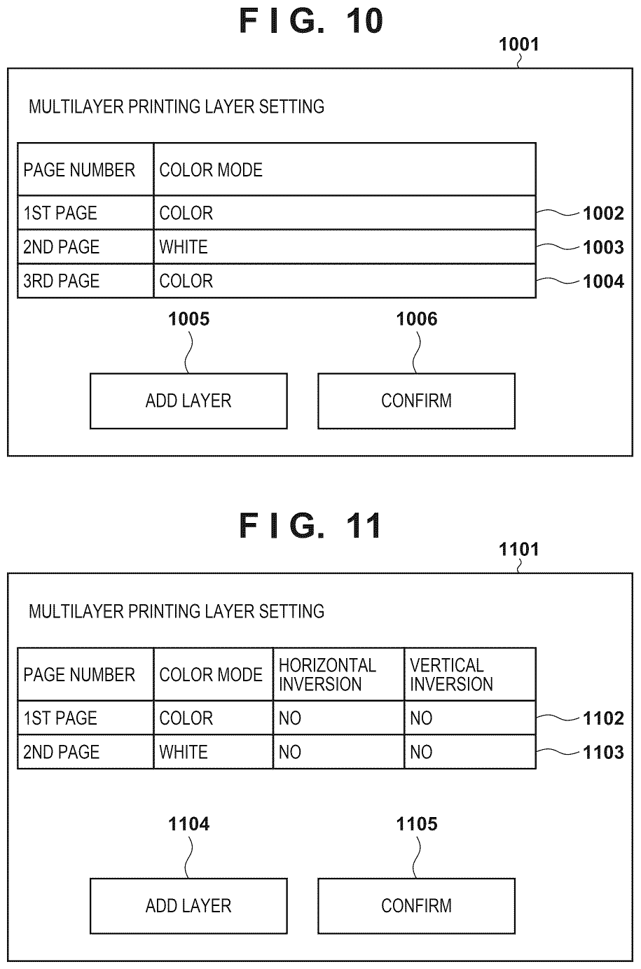

FIGS. 9 and 10 are diagrams illustrating examples of a multilayer-printing individual-layer setting screen displayed on the input/output device 162. Hereinafter, the multilayer-printing individual-layer setting screen is referred to as a layer setting screen. The layer setting screen is a screen for setting a printing mode of page data corresponding to each layer in a case in which print data set for single-sided printing is to be printed by multilayer printing. In the present embodiment, an example will be described in which, on the layer setting screen, a printing mode relating to color mode is set for each page data.

On a layer setting screen 901, setting-target page numbers, printing-mode setting portions 902 and 903 corresponding to the page numbers, an add button 904, and a confirm button 905 are displayed. The page numbers correspond to individual layers in multilayer printing.

For example, the printing-mode setting portions 902 and 903 are interfaces via which the selection of a color mode for each page data included in a print job can be accepted. In the example in FIG. 9, the printing-mode setting portion 902 has accepted a selection of “color” as the color-mode setting for page data for the first page. Furthermore, the printing-mode setting portion 903 has accepted a selection of “white” as the color mode for page data for the second page. The user selects and sets in advance, via the layer setting screen 901, a printing mode (color mode) for each page data in multilayer printing. Note that, while the two color-mode settings “color” and “white” are illustrated here, “black” can also be selected as a color-mode setting in the printing-mode setting portions.

Here, if the color mode “color” is set to page data, the layer corresponding to the page data will be printed in the color(s) indicated by pixel data included in the page data. On the other hand, if the color mode “white” is set to page data, the layer corresponding to the page data will be printed in a state in which pixel data included in the page data is replaced with pixel data of a specific color (white) used for masking. That is, it can be said that the present screen is a screen for setting, for each page data included in a print job, whether or not to execute a printing mode for providing a masking layer in the printed material to be obtained by multilayer printing. Furthermore, the printing mode for providing a masking layer is a mode in which printing is executed such that at least part of a page area represented by the page data is covered up with a recording material of a specific color.

For example, the add button 904 is an interface via which the addition of page data to which a printing mode is to be set can be accepted. When the add button 904 is pressed by the user, the printer controller 120 adds a printing-mode setting portion to the layer setting screen 901. Here, reference will be made to FIG. 10. FIG. 10 illustrates an example of a layer setting screen in a case in which the add button 904 illustrated in FIG. 9 has been pressed by the user. As illustrated in FIG. 10, an interface (printing-mode setting portion 1004) via which a selection of a printing-mode setting for page data for the third page can be accepted has been added in a layer setting screen 1001. In such a manner, by using the add button, the number of printing-mode settings can be increased in accordance with the number of pages. Note that, on the layer setting screen, an interface via which the deletion of printing-mode-setting-target page data can be accepted may be displayed, for example.

The confirm button 905 is an interface via which an instruction for confirming the printing-mode setting for each page data selected using the printing-mode setting portions 902 and 903 can be accepted. For example, if the confirm button 905 is pressed, the printer controller 120 stores the selection of the printing mode for each page data having been accepted via the printing-mode setting portions 902 and 903 in a memory such as the ROM 123 as an apparatus setting.

In steps S609 to S617, the printer controller 120 repeats the following processing for page data for the first to Nth pages based on the settings established via the layer setting screen. In other words, the printer controller 120 repeats the processing in steps S610 to S616 in the order of the page data included in the print data.

In step S610, based on the multilayer-printing layer setting information referred to in step S608, the printer controller 120 determines the printing mode for the image-processing-target page data from among color, white, and black. In other words, in step S610, the printer controller 120 determines the printing mode (color mode) set to each page data. The printer controller 120 advances to step S611 if it is determined in step S610 that the printing mode is color. The printer controller 120 advances to step S612 if it is determined in step S610 that the printing mode is white. The printer controller 120 advances to step S614 if it is determined in step S610 that the printing mode is black.

In S611, the printer controller 120, using the image-forming unit 203, expands the target page data into the image buffer as layer data. Then, in step S616, the printer controller 120, using the job-outputting unit 204, controls the printer engine 150 so as to print the layer data expanded into the image buffer in step S611.

In step S612, the printer controller 120, using the image-forming unit 203, replaces pixel data included in the target page data with white pixel data. For example, if pixel data is set to the entire page area represented by the page data, the entire page area is replaced with white pixel data as a result of the processing in step S612. In step S613, the printer controller 120, using the image-forming unit 203, expands the page data replaced with white pixel data in step S612 into the image buffer as layer data. Then, in step S616, the printer controller 120, using the job-outputting unit 204, controls the printer engine 150 so as to print the layer data expanded into the image buffer in step S613. For example, if pixel data is set to the entire page area represented by the page data, the entire page area is replaced with white pixel data as a result of the processing in step S612. Then, a masking layer is formed by white ink being printed on the entire page area as a result of the processing in step S616.

In step S614, the printer controller 120, using the image-forming unit 203, replaces the pixel area portion of the printing-target page data with black pixel data. For example, if pixel data is set to the entire page area represented by the page data, the entire page area is replaced with black pixel data as a result of the processing in step S614. In step S615, the printer controller 120, using the image-forming unit 203, expands the page data in which the pixel area portion has been replaced with black pixel data in step S614 into the image buffer as layer data. Then, in step S616, the printer controller 120, using the job-outputting unit 204, controls the printer engine 150 so as to print the layer data expanded into the image buffer in step S615. For example, in a case in which pixel data is set to the entire page area represented by the page data, the entire page area is replaced with black pixel data as a result of the processing in step S614. Then, a masking layer is formed by black ink being printed on the entire page area as a result of the processing in step S616.

In step S617, if the processing in steps S610 to S616 for the plurality of pages included in the print job is complete, the printer controller 120 exits the loop processing in step S617 and terminates the processing in FIGS. 6A and 6B.

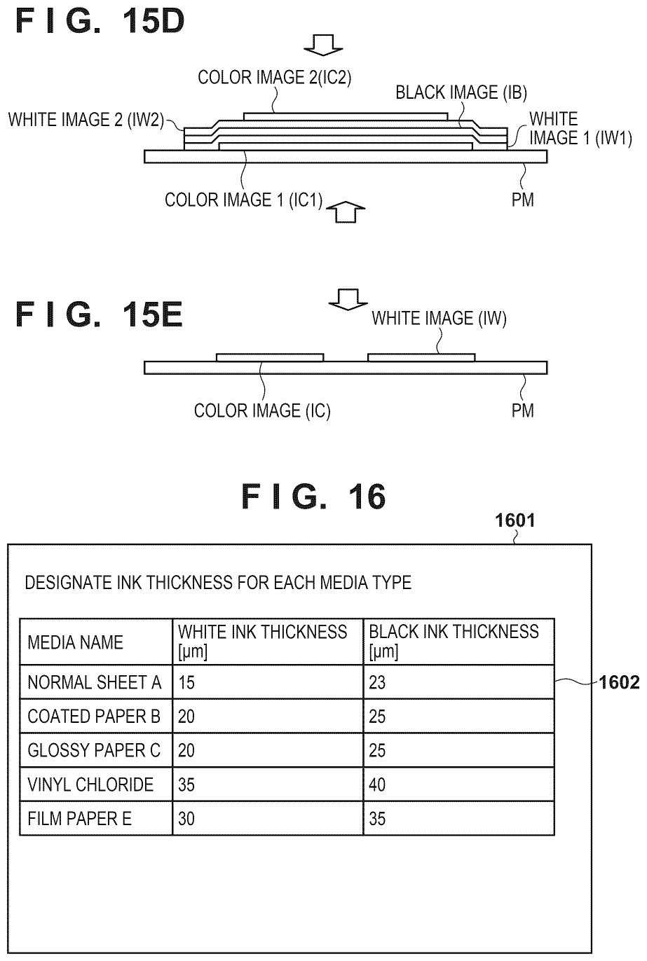

Here, with reference to FIGS. 15A to 15D, examples of printed materials in cases in which multilayer printing has been executed as a result of the processing in FIGS. 6A and 6B will be described. FIGS. 15A to 15D each illustrate an example of a print pattern in a case in which single-sided printing is designated in the print setting information and multilayer printing is set as an apparatus setting.

FIG. 15A illustrates a print pattern in which a white image IW (first layer) is formed on a transparent film that is a printing medium PM, and a color image IC (second layer) is formed on the white image IW. In the present print pattern, the color image IC is masked by the white image IW if the transparent film is viewed from the reverse side from the print side of the transparent film. Accordingly, in the case of the present print pattern, a viewer would view the printed material from the upper side in the drawing (arrow in the drawing).

FIG. 15B illustrates a print pattern in which a color image IC (first layer) is formed on a transparent film that is a printing medium PM, and a white image IW (second layer) is formed on the color image IC. In the present print pattern, the color image IC is masked by the white image IW if the transparent film is viewed from the print side of the transparent film. That is, the white image IW formed from white ink is a masking layer. Accordingly, in the case of the present print pattern, a viewer would view the printed material from the lower side in the drawing (arrow in the drawing).

FIG. 15C illustrates a print pattern in which a color image IC1 (first layer) is formed on a transparent film that is a printing medium PM, a white image IW (second layer) is formed on the color image IC1, and a color image IC2 (third layer) is further formed on the white image IW. In the present print pattern, the color image IC1 is masked by the white image IW if the transparent film is viewed from the print side of the transparent film. On the other hand, the color image IC2 is masked by the white image IW if the transparent film is viewed from the reverse side from the print side of the transparent film. That is, the white image IW formed from white ink is a masking layer. Accordingly, in the case of the present print pattern, a viewer would view the printed material from the upper and lower sides in the drawing (arrows in the drawing).

FIG. 15D illustrates a print pattern in which images are formed on a transparent film that is a printing medium PM in the order of a color image IC1 (first layer), a white image IW1 (second layer), a black image IB (third layer), a white image IW2 (fourth layer), and a color image IC2 (fifth layer). In the present print pattern, the color image IC1 is masked by the white image IW1, the black image IB, and the white image IW2 if the transparent film is viewed from the print side of the transparent film. On the other hand, the color image IC2 is masked by the white image IW1, the black image IB, and the white image IW2 if the transparent film is seen from the reverse side from the print side of the transparent film. That is, the white images IW formed from white ink and the black image IB formed from black ink are masking layers. In such a manner, in the present print pattern, the masking rate can be increased compared to that in the print pattern in FIG. 15C by providing a black ink layer (black image IB) in the middle as a masking layer. Furthermore, in the case of the present print pattern, a viewer would view the printed material from the upper and lower sides in the drawing (arrows in the drawing).

FIG. 15E illustrates a print pattern in which a color image IC and a white image IW are formed in different print areas on a transparent film that is a printing medium PM. In the case of the present print pattern, a viewer would view the printed material from the upper side and lower sides in the drawing (arrow in the drawing).

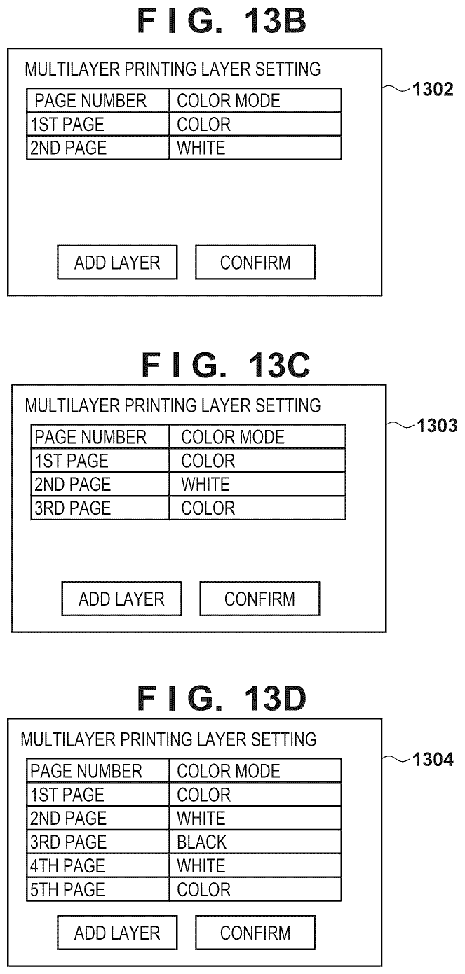

Here, with reference to FIGS. 13A to 13D, layer setting screens for forming the print patterns illustrated in FIGS. 15A to 15D will be described.

FIG. 13A illustrates a layer setting screen for forming the print pattern in FIG. 15A. In a layer setting screen 1301, the printing mode set to each page data is white for the first page (first layer) and color for the second page (second layer). Such printing-mode settings enable the print pattern in FIG. 15A to be formed on a printing medium.

FIG. 13B illustrates a layer setting screen for forming the print pattern in FIG. 15B. In a layer setting screen 1302, the printing mode set to each page data is color for the first page (first layer) and white for the second page (second layer). Such printing-mode settings enable the print pattern in FIG. 15B to be formed on a printing medium.

FIG. 13C illustrates a layer setting screen for forming the print pattern in FIG. 15C. In a layer setting screen 1303, the printing mode set to each page data is color for the first page (first layer) and the third page (third layer), and white for the second page (second layer). Such printing-mode settings enable the print pattern in FIG. 15C to be formed on a printing medium.

FIG. 13D illustrates a layer setting screen for forming the print pattern in FIG. 15D. In a layer setting screen 1304, the printing mode set to each page data is color for the first page (first layer) and the fifth page (fifth layer), white for the second page (second layer) and the fourth page (fourth layer), and black for the third page (third layer). Such printing-mode settings enable the print pattern in FIG. 15D to be formed on a printing medium.

Furthermore, for example, print data in which pieces of pixel data corresponding to different pieces of page data are disposed so as not to overlap one another on a recording medium when multilayer printing is executed shall be considered. For such print data, a print pattern such as that in FIG. 15E can be formed by setting the printing mode of each page data to color for the first page and white for the second page on a layer setting screen.

As described up to this point, according to the present embodiment, the image forming apparatus 100 establishes, based on a user operation for each page data included in print data, a setting of whether or not to execute a printing mode for providing a masking layer in a printed material to be obtained by multilayer printing. If print data is acquired, and single-sided printing is set to the print data and the print data is set to be printed by multilayer printing, the image forming apparatus 100 generates image data by executing image processing on page data as layer data. The image processing is executed based on a setting, for each of the page data, of whether or not to execute a printing mode for forming a masking layer in the printed material to be obtained by multilayer printing. Furthermore, the image forming apparatus 100 performs control so that multilayer printing is executed on the printing medium based on the generated image data. According to such an embodiment, the image forming apparatus 100 can perform control such that a print job including page data set for single-sided printing is printed by multilayer printing based on a setting of whether or not to provide a masking layer for each page data.

Furthermore, according to such an embodiment, for example, the user sets in advance to the image forming apparatus 100 whether or not to execute the printing mode for forming a masking layer in the printed material to be obtained by multilayer printing. Then, the user can obtain a printed material printed by multilayer printing by using a general-purpose printing application on the host-computer-190 side, for example, to create print data including page data and transmitting the print data to the image forming apparatus 100. That is, a printed material printed by multilayer printing can be obtained based on settings on the image-forming-apparatus-100 side without the need of a special application capable of creating layer data.

### Second Embodiment

In the following, a second embodiment will be described focusing on the differences from the first embodiment. For example, in a case in which multilayer printing is executed on one side of a transparent printing medium such as a transparent film, the printed material printed on the printing medium can be viewed from both sides, i.e., the front side (printed side) and the back side (unprinted side). However, with such a transparent printing medium, the printed material may appear inverted depending on the printed material. In view of this, in the present embodiment, it is set to the image forming apparatus 100 in advance whether or not to execute, for each page data, at least one of vertical inversion processing and horizontal inversion processing on image data. Then, after printing-target page data is expanded into the image buffer as layer data, image processing for inverting image data that is the layer data is executed based on the setting. Then, printing of the image data is executed. According to such an embodiment, even in a case in which multilayer printing is executed using a printing medium, such as a transparent film, on which a printed material can be seen from both sides, for example, a situation can be prevented in which the design of the printed material appears inverted.

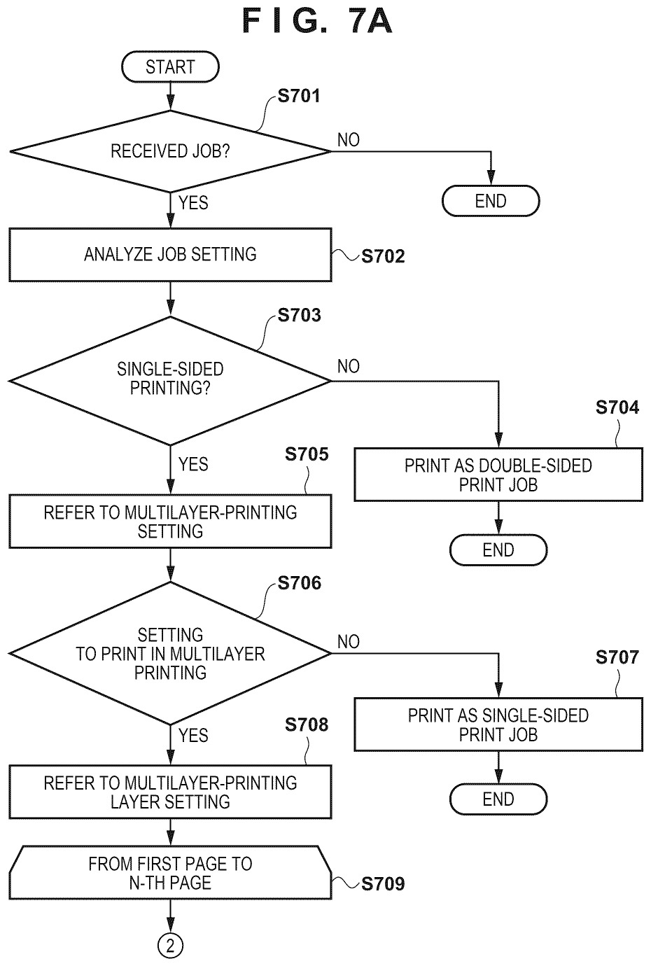

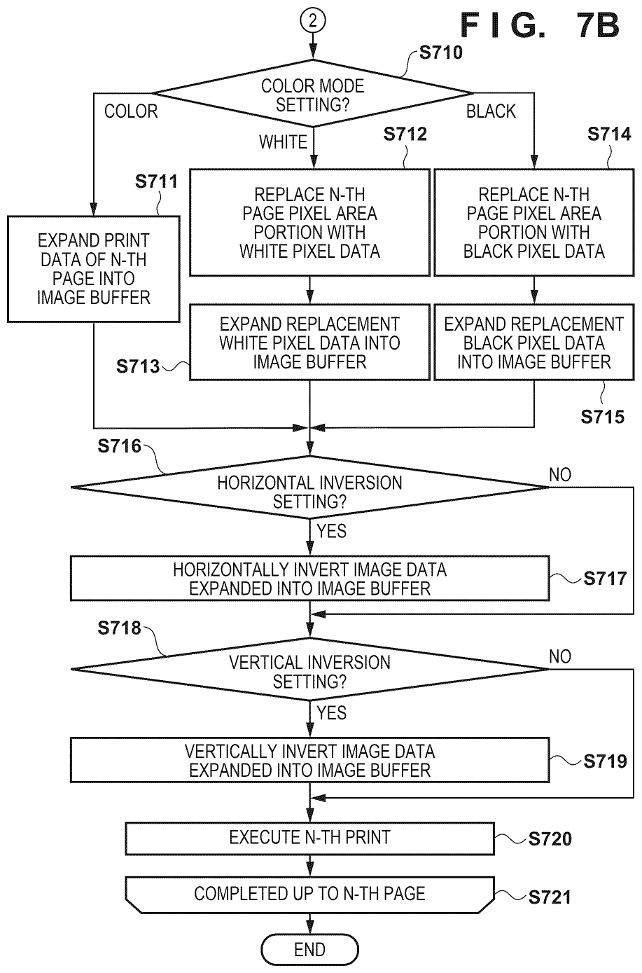

FIGS. 7A and 7B are flowcharts illustrating processing by the printer controller 120 in a case in which a print job is received in the present embodiment. For example, the processing in FIGS. 7A and 7B are realized by the CPU 128 loading a program stored in the ROM 123 into the RAM 124 and executing the program.

The processing in steps S701 to S715 is the same as the processing in steps S601 to S615, and description thereof is thus omitted.

In step S716, the printer controller 120, using the job-analyzing unit 202, refers to settings relating to inversion processing. Then, based on the settings relating to inversion processing, the printer controller 120 determines whether or not to execute horizontal inversion processing on the layer data stored in the image buffer. The printer controller 120 advances to step S718 upon determining not to execute horizontal inversion processing. On the other hand, the printer controller 120 advances to step S717 upon determining to execute horizontal inversion processing.

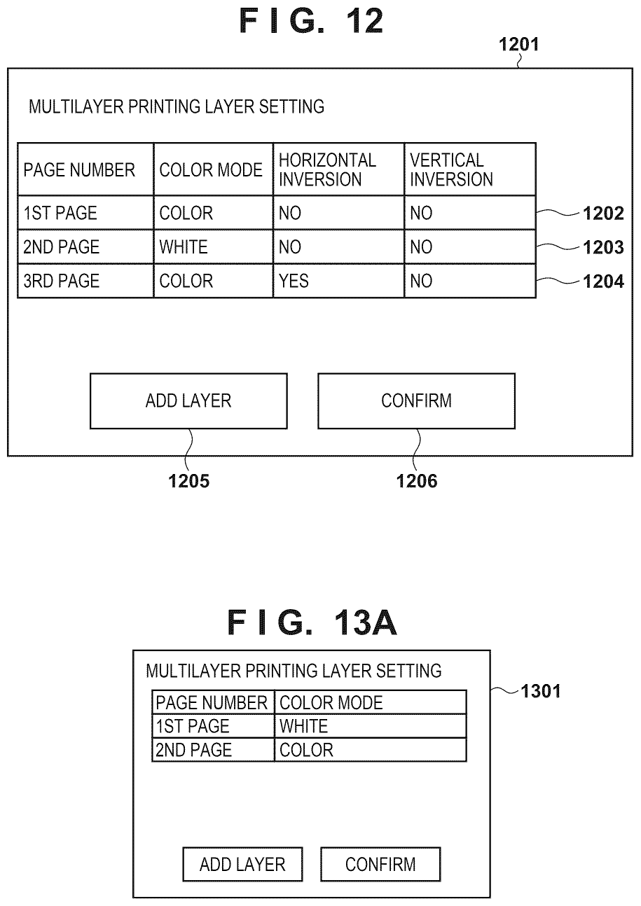

Here, with reference to FIGS. 11 and 12, layer setting screens in the present embodiment will be described. FIGS. 11 and 12 are diagrams for describing the settings relating to inversion processing referred to in steps S716 and S718.

As illustrated in FIG. 11, inversion-processing setting portions 1102 and 1103 are displayed on a layer setting screen 1101 in the present embodiment. The inversion-processing setting portions 1102 and 1103 are interfaces via which a selection of whether or not to execute at least one of vertical inversion processing and horizontal inversion processing can be accepted for each page data. The user selects and sets in advance, via the layer setting screen 1101, whether or not to execute inversion processing for each page data in multilayer printing.

Furthermore, for example, when an add button 1104 is pressed by the user, the printer controller 120 adds an inversion-processing setting portion to the layer setting screen 1101. Here, reference will be made to FIG. 12. FIG. 12 illustrates an example of a layer setting screen in a case in which the add button 1104 illustrated in FIG. 11 has been pressed by the user. As illustrated in FIG. 12, an interface (inversion-processing setting portion 1204) via which a selection of a setting of whether or not to execute inversion processing on page data for the third page can be accepted has been added in a layer setting screen 1201.

In the present embodiment, a confirm button 1105 is an interface via which an instruction to confirm the setting for each page data selected using the inversion-processing setting portions 1102 and 1103 of whether or not to execute inversion processing can be accepted. For example, if the confirm button 1105 is pressed, the printer controller 120 stores the inversion-processing settings that have been selected and accepted via the inversion-processing setting portions 1102 and 1103 in a memory such as the ROM 123 as apparatus settings.

In step S717, the printer controller 120, using the image-forming unit 203, executes horizontal inversion processing on the layer data stored in the image buffer. The horizontal inversion processing, in other words, is processing for reversing the left and right sides of the layer data. The horizontal inversion processing can also be regarded as processing for rotating the layer data 180 degrees in the horizontal direction.

In step S718, the printer controller 120, using the job-analyzing unit 202, refers to the settings relating to inversion processing. Then, based on the settings relating to inversion processing, the printer controller 120 determines whether or not to execute vertical inversion processing on the layer data stored in the image buffer. The printer controller 120 advances to step S719 upon determining to execute vertical inversion processing. On the other hand, the printer controller 120 advances to step S720 upon determining not to execute vertical inversion processing.

In step S719, the printer controller 120 executes vertical inversion processing on the layer data stored in the image buffer. The vertical inversion processing, in other words, is processing for reversing the upper and lower sides of the layer data. The vertical inversion processing can also be regarded as processing for rotating the layer data 180 degrees in the vertical direction.

In step S720, printing of the Nth layer is completed as a result of the printer controller 120 executing printing of the layer data expanded into the image buffer. Furthermore, an image (printed material) is generated by multilayer printing as a result of the steps from step S709 to step S721 being repeated a number of times corresponding to the number of pages in the print job.

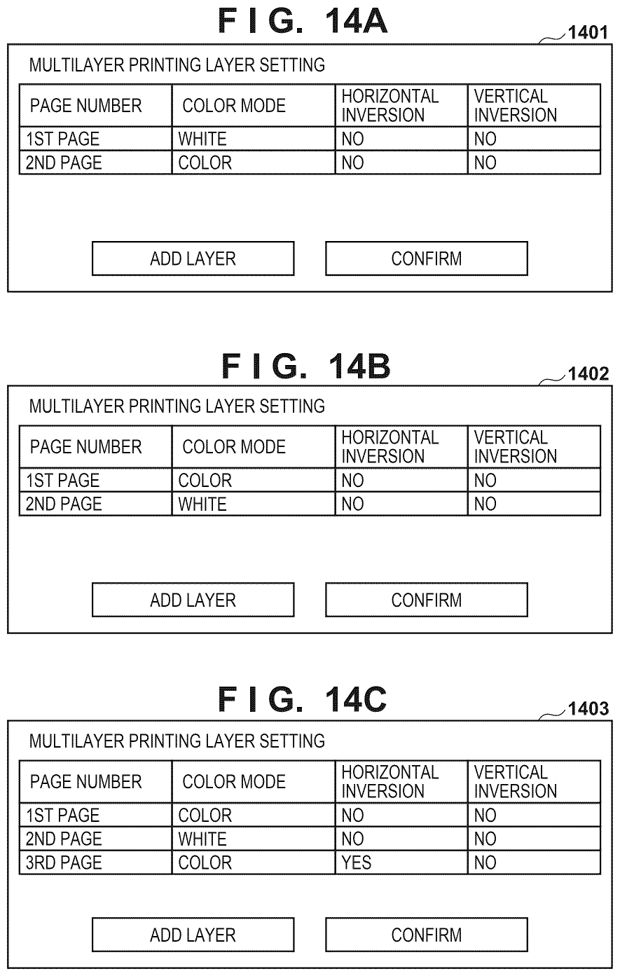

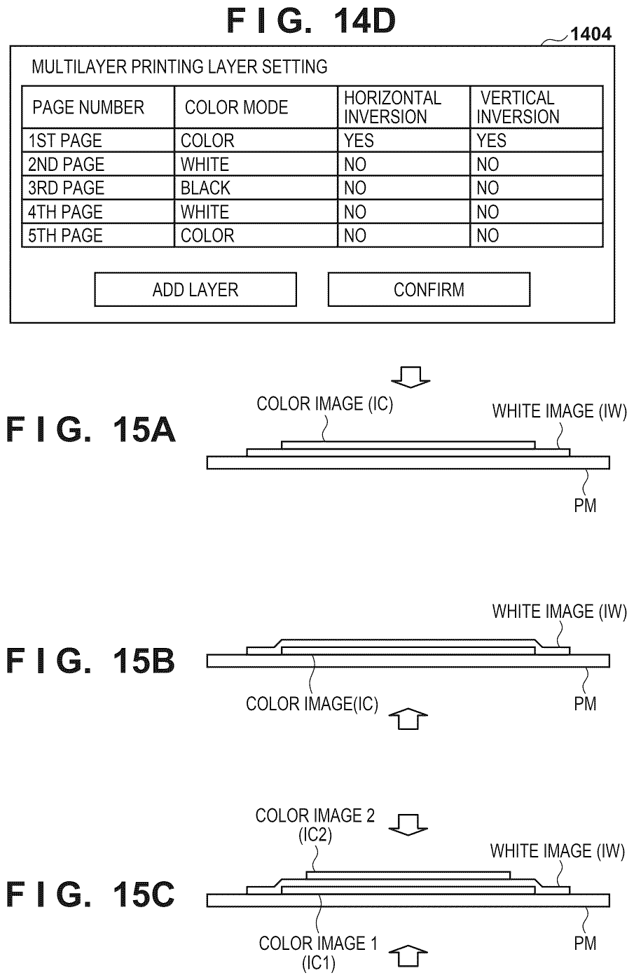

Here, with reference to FIGS. 14A to 14D, layer setting screens for forming the print patterns illustrated in FIGS. 15A to 15D in the present embodiment will be described.

In a layer setting screen 1401 in FIG. 14A, the page data for each of the first and second pages is set so that inversion processing will not be executed. Such settings enable the print pattern in FIG. 15A to be formed on a printing medium.

Similarly, in a layer setting screen 1402 in FIG. 14B, the page data for each of the first and second pages is set so that inversion processing will not be executed. Such settings enable the print pattern in FIG. 15B to be formed on a printing medium.

In a layer setting screen 1403 in FIG. 14C, the page data for each of the first and second pages is set so that inversion processing will not be executed. On the other hand, the page data for the third page is set so that horizontal inversion processing will be executed. Such settings enable the print pattern in FIG. 15C to be formed on a printing medium, and, furthermore, results in the color image IC2 (third layer) being formed so as to be inverted horizontally.

In a layer setting screen 1404 in FIG. 14D, the page data for the first page is set so that both vertical inversion processing and horizontal inversion processing will be executed. On the other hand, the page data for each of the second to fifth pages is set so that inversion processing will not be executed. Such settings enable the print pattern in FIG. 15D to be formed on a printing medium, and, furthermore, results in the color image IC1 (first layer) being formed so as to be inverted vertically and horizontally.

As described up to this point, according to the present embodiment, an inversion-processing setting portion for setting whether or not to execute at least one of vertical inversion processing and horizontal inversion processing on image data generated by the image-forming unit 203 is displayed on a layer setting screen. Furthermore, if a setting to invert the image data has been established, the image data is inverted in at least one of the vertical and horizontal directions. According to such an embodiment, even in a case in which multilayer printing is executed using a printing medium, such as a transparent film, on which a printed material can be seen from both sides, a situation can be prevented in which the design of the printed material appears inverted. Furthermore, upon creating print data, the user can create the print data easily taking into account vertical and horizontal inversions that may occur when the print data is viewed from the back side.

### Third Embodiment

In the following, a third embodiment will be described focusing on the differences from the first and second embodiments. The transmittance of light varies depending on printing medium type. Thus, the necessary masking layer thickness when forming a masking layer on a printing medium using ink of a specific color differs depending on printing medium type. In view of this, in this embodiment, masking layer thickness for different types of printing media can be set to the image forming apparatus 100. Furthermore, the image forming apparatus 100 prints a masking layer so as to have the set thickness.

FIG. 16 is a diagram illustrating an example of a screen via which the thickness of a recording material of a specific color can be set. A setting screen 1601 is a screen displayed on the input/output device 162, and, on the setting screen 1601, the user selects and sets in advance the thickness of a recording material of a specific color for different types of printing media as apparatus settings. The setting screen 1601 includes a thickness setting portion 1602. The thickness setting portion 1602 is an interface via which a setting of the thickness of a recording material of a specific color is accepted for different types of printing media. In the present embodiment, the thickness setting portion 1602 accepts a setting of thickness individually for each of white and black inks, which are recording materials of specific colors used for image masking. That is, the setting screen 1601 is a screen for setting masking layer thickness for different types of printing media. Note that, for example, the thickness setting portion 1602 may be an interface via which numerical values can be input, or may be an interface via which a selection can be made from among numerical values prepared in advance. For example, if a numerical value is accepted via the thickness setting portion 1602, the printer controller 120 stores the numerical value in a memory such as the ROM 123 as thickness information. In such a manner, the thickness of a recording material of a specific color for different types of printing media is set as apparatus settings of the image forming apparatus 100.

Note that, while description has been provided in the present embodiment taking as an example a screen via which the thickness of a recording material of a specific color can be set, there is no limitation to this. For example, a screen via which the ejection amount of a recording material of a specific color can be set may be displayed on the input/output device 162, and a configuration may be adopted such that the ejection amount of ink of a specific color is selected and set in advance for different types of printing media as apparatus settings.

In the following, an example of processing by the printer controller 120 in a case in which a print job is received in the present embodiment will be described. As described above, upon receiving a print job from the host computer 190, the printer controller 120 generates image data and executes printing thereof (see FIGS. 6 and 7). The print job includes print setting information. The print setting information includes information designating printing medium type. Thus, in the present embodiment, upon receiving the print job transmitted from the host computer 190, the printer controller 120, using the job-analyzing unit 202, analyzes the information designating printing medium type included in the print setting information. Then, the printer controller 120 executes processing that is the same as that in steps S603 to S615 or steps S703 to S719. Subsequently, in the present embodiment, the printer controller 120, using the job-analyzing unit 202, refers to the ink-thickness settings for different types of printing media stored in the ROM 123. In the present embodiment, if the thickness of ink of a specific color for different types of printing media has been set via the setting screen 1601, the printing by the printer engine 150 is executed based on the thickness settings. Specifically, upon printing layer data for which the color mode during printing is white or black, the printer controller 120 controls the printer engine 150 so that the layer data is printed based on the settings of the thickness of the ink of the specific color for different types of printing media. For example, the printer engine 150 performs control so that ink thickness equals a set value by increasing the ink ejection amount from the print head 151.

In the present embodiment, an example has been described in which ink thickness is controlled by increasing the ejection amount of ink of a specific color; however, masking layer thickness may be controlled by forming a white (black) ink layer by printing multiple layers.

As described up to this point, according to the present embodiment, masking layer thickness can be changed for different types of printing media in multilayer printing by setting in advance to the image forming apparatus 100 via the screen 1601 the thickness of ink of a specific color for different types of printing media. According to such an embodiment, even in a case in which multilayer printing is executed on a printing medium such as a transparent film on which a printed material can be seen from both sides, for example, a printed material similar to that in a case in which double-sided printing is executed can be obtained by increasing masking layer thickness.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090922, filed Jun. 4, 2024 which is hereby incorporated by reference herein in its entirety.

What is claimed is:

1. An image forming apparatus comprising:
at least one memory and at least one processor which function as:
an acquiring unit configured to acquire print setting information and print data that includes page data for at least one page;
a first setting unit configured to set whether or not to print the print data by multilayer printing;
a second setting unit configured to establish, for each of the page data, a setting of whether or not to execute a printing mode for forming a masking layer in a printed material to be obtained by the multilayer printing;
a generating unit configured to, if single-sided printing is set to the print data in the print setting information and the print data is set to be printed by the multilayer printing, generate image data by executing, on the page data as layer data, image processing based on the setting established by the second setting unit; and
a control unit configured to control a printing unit so as to execute printing by the multilayer printing on a printing medium based on the image data generated by the generating unit.

2. The image forming apparatus according to claim 1,
wherein the printing mode is a mode in which printing is executed such that at least part of a page area represented by the page data is covered up with a recording material of a specific color.

3. The image forming apparatus according to claim 2,
wherein the specific color includes at least one of white and black.

4. The image forming apparatus according to claim 2,
wherein the specific color includes a color used for image masking.

5. The image forming apparatus according to claim 1,
wherein the at least one memory and the at least one processor further function as
a third setting unit configured to set a thickness of the masking layer for different types of the printing medium, and
if the thickness of the masking layer has been set by the third setting unit, the masking layer having the set thickness is printed on the printing medium by the printing unit.

6. The image forming apparatus according to claim 2,
wherein the recording material is ink.

7. The image forming apparatus according to claim 1,
wherein the at least one memory and the at least one processor further function as
a fourth setting unit configured to establish a setting of whether or not to execute at least one of vertical inversion processing and horizontal inversion processing on the image data generated by the generating unit, and
the generating unit executes at least one of the vertical inversion processing and the horizontal inversion processing on the image data if the setting has been established by the fourth setting unit.

8. The image forming apparatus according to claim 1,
wherein the generating unit generates the image data in the order of the page data.

9. The image forming apparatus according to claim 1,
wherein the printing medium is a transparent printing medium.

10. The image forming apparatus according to claim 1,
wherein the image processing includes expansion into an image buffer.

11. The image forming apparatus according to claim 1,
wherein the print setting information and the print data are print setting information and print data that have been transmitted to the image forming apparatus after being generated by a device external to the image forming apparatus.

12. A method for controlling an image forming apparatus, the method comprising:
acquiring print setting information and print data that includes page data for at least one page;
setting whether or not to print the print data by multilayer printing;
establishing, for each of the page data, a setting of whether or not to execute a printing mode for forming a masking layer in a printed material to be obtained by the multilayer printing;
if single-sided printing is set to the print data in the print setting information and the print data is set to be printed by the multilayer printing, generating image data by executing, on the page data as layer data, image processing based on the setting established by the establishing; and
controlling printing in which printing is executed by the multilayer printing on a printing medium based on the image data generated by the generating.

13. A non-transitory computer-readable storage medium storing a program configured to cause a computer to function as:
an acquiring unit configured to acquire print setting information and print data that includes page data for at least one page;
a first setting unit configured to set whether or not to print the print data by multilayer printing;
a second setting unit configured to establish, for each of the page data, a setting of whether or not to execute a printing mode for forming a masking layer in a printed material to be obtained by the multilayer printing;
a generating unit configured to, if single-sided printing is set to the print data in the print setting information and the print data is set to be printed by the multilayer printing, generate image data by executing, on the page data as layer data, image processing based on the setting established by the second setting unit; and
a control unit configured to control a printing unit so as to execute printing by the multilayer printing on a printing medium based on the image data generated by the generating unit.
